(19) United States
(12) Patent Application Publication
(10) Pub. No.: US 2005/0083048 A1
(43) Pub. Date: Apr. 21, 2005

(54) Plating system with integrated substrate inspection

(75) Inventors: Lawrence Chung-Lai Lei, Milpitas, CA (US); Chen-An Chen, Milpitas, CA (US)

Correspondence Address: MOSER, PATTERSON & SHERIDAN, LLP/;APPLIED MATERIALS, INC., 3040 POST OAK BOULEVARD, SUTIE 1500, HOUSTON, TX, 77056, US

(73) Assignee: APPLIED MATERIALS, INC.

(21) Appl. No.: 10/970,351

(22) Filed: Oct. 21, 2004

Related U.S. Application Data
(60) Provisional application No. 60/513,310, filed on Oct. 21, 2003.

(51) Int. Cl. G01B 7/06; B44C 1/22

(52) U.S. Cl. 324/229; 216/37

(57) ABSTRACT

Embodiments of the invention generally provide an electrochemical plating system. The plating system includes a substrate loading station positioned in communication with a mainframe processing platform, at least one substrate plating cell positioned on the mainframe, and at least one substrate inspection station positioned on either the mainframe or in the loading station. The inspection station is generally configured to use an eddy current sensing device to determine the thickness of a conductive layer on the substrate.

### CROSS-REFERENCE TO RELATED APPLICATIONS

This application claims benefit of U.S. provisional patent application Ser. No. 60/513,310, filed Oct. 21, 2003, which is herein incorporated by reference.

### BACKGROUND OF THE INVENTION

1. Field of the Invention

Embodiments of the invention generally relate to an electrochemical plating system having an integrated substrate inspection system.

2. Description of the Related Art

Metallization of sub-quarter micron sized features is a foundational technology for present and future generations of integrated circuit manufacturing processes. More particularly, in devices such as ultra large scale integration-type devices, i.e., devices having integrated circuits with more than a million logic gates, the multilevel interconnects that lie at the heart of these devices are generally formed by filling high aspect ratio, i.e., greater than about 4:1, interconnect features with a conductive material, such as copper. Conventionally, deposition techniques such as chemical vapor deposition (CVD) and physical vapor deposition (PVD) have been used to fill these interconnect features. However, as the interconnect sizes decrease and aspect ratios increase, void-free interconnect feature fill via conventional metallization techniques becomes increasingly difficult. Therefore, plating techniques, i.e., electrochemical plating (ECP) and electroless plating, have emerged as promising processes for void free filling of sub-quarter micron sized high aspect ratio interconnect features in integrated circuit manufacturing processes.

In an ECP process, sub-quarter micron sized high aspect ratio features formed on the surface of a substrate (or a layer deposited thereon) may be efficiently filled with a conductive material. ECP processes are generally two stage processes, wherein a seed layer is first formed over the surface features of the substrate (generally through PVD, CVD, or other deposition process in a separate tool), and then the surface features of the substrate are exposed to an electrolyte solution (in the ECP tool), while an electrical bias is applied between the seed layer and a copper anode positioned within the electrolyte solution. The electrolyte solution generally contains ions to be plated onto the surface of the substrate, and therefore, the application of the electrical bias causes these ions to be plated onto the biased seed layer, thus depositing a layer of the ions on the substrate surface that may fill the features.

Once the plating process is completed, the substrate is generally transferred to at least one of a substrate rinsing cell or a bevel clean cell. Bevel edge clean cells are generally configured to dispense an etchant onto the perimeter or bevel edge of the substrate to remove unwanted metal plated thereon. The substrate rinse cells, often called spin rinse dry cells, generally operate to rinse the surface of the substrate (both front and back) with a rinsing solution to remove any contaminants therefrom. Further, the rinse cells are often configured to spin the substrate at a high rate of speed in order to spin off any remaining fluid droplets adhering to the substrate surface. Once the remaining fluid droplets are spun off, the substrate is generally clean and dry, and ready for transfer from the ECP tool. The bevel clean cells generally operate to clean the bevel of the substrate by dispensing an etchant solution onto the bevel while the substrate is rotated under the fluid dispensing nozzle. The etchant solution operates to clean the bevel of any unwanted materials generated during plating processes.

Thereafter, the cleaned/rinsed substrate is often transferred to an annealing chamber where the substrate is heated to a temperature sufficient to anneal the deposited film. However, the throughput of conventional plating systems may be limited by the availability of the annealing chamber, as an annealing process for a semiconductor substrate after plating may take several minutes. Further, once the annealing process is completed, the annealed substrate generally takes several minutes to cool down to a temperature that allows for transfer of the substrate to another processing chamber or device.

Accuracy in each of the above noted processes is critical to the overall success of plating processes for sub-quarter micron devices. More particularly, as multi-chemistry plating systems develop, accuracy in the thicknesses of plated layers, i.e., seed layers, seed layer repair layers, gap fill layers, bulk fill layers, etc. becomes critical to optimizing multi-chemistry processes. Conventionally, four point probe eddy current measurement methods have been used to determine the thickness of layers on a substrate. However, conventional four point probe methods have several disadvantages. For example, four point probe methods require physical contact with the substrate, which has been shown to cause damage to the substrate, i.e., the method is destructive to the substrate and/or layers formed thereon. Additionally, the contact between the probes and the substrate has been shown to increase oxidation at the contact points, which is also undesirable. Further, four point probe methods require precision mechanical devices to support the probe elements, which are difficult to control and maintain.

Another conventional layer thickness measurement technique that has been tried is opto-acoustic measurements. Although opto-acoustic methods are non-destructive and relatively accurate, opto-acoustic methods are expensive, and therefore, they are also undesirable.

Therefore, there is a need for an electrochemical plating system having multiple plating cells capable of using multiple chemistries, wherein the plating system includes a substrate inspection system.

### SUMMARY OF THE INVENTION

Embodiments of the invention generally provide an electrochemical plating system. The plating system generally includes a substrate loading station positioned in communication with a mainframe processing platform, at least one substrate plating cell positioned on the mainframe, an annealing station positioned in communication with at least one of the mainframe and/or the loading station, and a substrate inspection station positioned either on the mainframe platform or in a factory interface or loading station section of the plating system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of one embodiment of an electrochemical plating system of the invention.

FIG. 2 illustrates an exemplary embodiment of a plating cell used in the electrochemical plating cell of the invention.

FIG. 3 illustrates a perspective view of an exemplary annealing system of the invention.

FIG. 4 illustrates an exemplary substrate inspection station of the invention.

FIG. 5 illustrates another embodiment of an exemplary substrate inspection station of the invention.

FIG. 6 illustrates an exemplary eddy current sensing coil arrangement of the invention.

FIG. 7 illustrates a plot of relative signal variation verses distance variation for a single sided coil configuration verses a double sided coil configuration.

### DETAILED DESCRIPTION OF THE PREFERRED EMBODIMENT

Embodiments of the invention generally provide a multi-chemistry electrochemical plating system configured to plate conductive materials onto semiconductor substrates. The plating system generally includes a substrate loading area in communication with a substrate processing platform. The loading area is generally configured to receive substrate cassettes and transfer substrates from the cassettes to the processing platform. The loading area generally includes a robot configured to transfer substrates to and from the cassettes and to the processing platform, a substrate annealing chamber, or a substrate inspection station positioned in the loading area. The processing platform generally includes at least one substrate transfer robot and a plurality of substrate processing cells, i.e., ECP cells, bevel clean cells, spin rinse dry cells, substrate cleaning cells, and/or electroless plating cells.

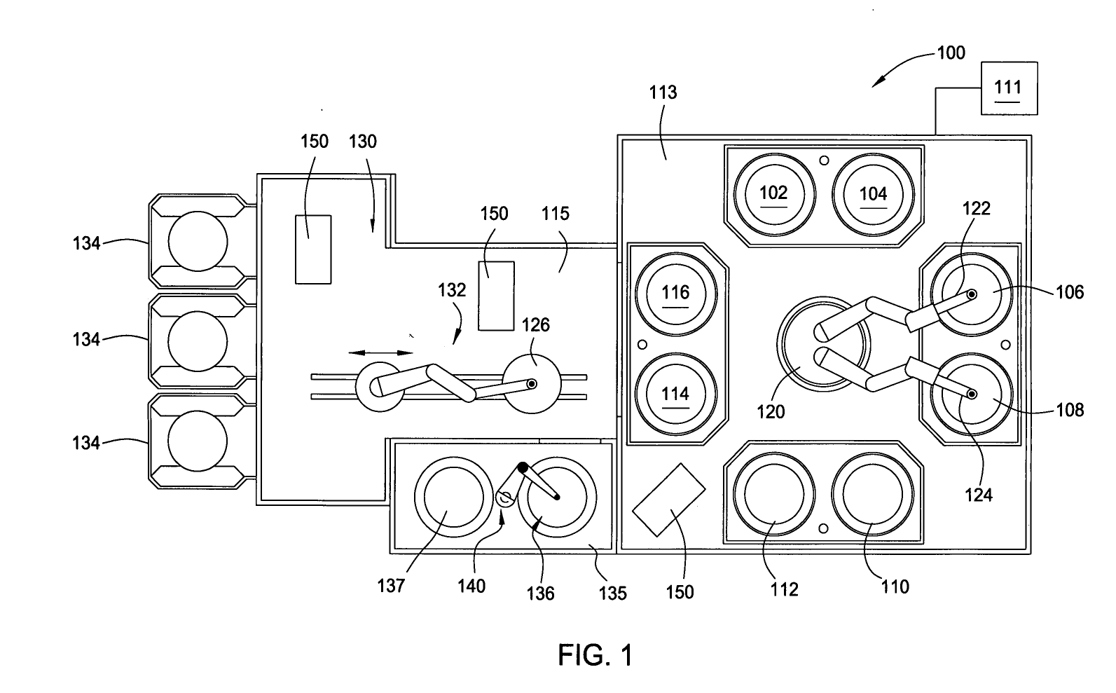

FIG. 1 illustrates a top plan view of an ECP system 100 of the invention. ECP system 100 includes a factory interface 130, which is also generally termed a substrate loading station. Factory interface 130 includes a plurality of substrate loading locations (positioned under cassettes 134) configured to interface with substrate containing cassettes 134. The factory interface and/or the link tunnel may include a substrate inspection station 150 positioned therein. A robot 132 is positioned in factory interface 130 and is configured to access substrates contained in the cassettes 134. Further, robot 132 also extends into a link tunnel 115 that connects factory interface 130 to processing mainframe or platform 113. The position of robot 132 allows the robot to access substrate cassettes 134 to retrieve substrates therefrom and then deliver the substrates to one of the processing cells 114, 116 positioned on the mainframe 113, or alternatively, to the annealing station 135 or to the substrate inspection station 150. Similarly, robot 132 may be used to retrieve substrates from the processing cells 114, 116 or the annealing chamber 135 after a substrate processing sequence is complete. In this situation robot 132 may deliver the substrate to the inspection station 150 or back to one of the cassettes 134 for removal from system 100.

The anneal station 135 generally includes a two position annealing chamber, wherein a cooling plate/position 136 and a heating plate/position 137 are positioned adjacently with a substrate transfer robot 140 positioned proximate thereto, e.g., between the two stations. The robot 140 is generally configured to move substrates between the respective heating 137 and cooling plates 136. Further, although the anneal chamber 135 is illustrated as being positioned such that it is accessed from the link tunnel 115, embodiments of the invention are not limited to any particular configuration or placement. As such, the anneal station 135 may be positioned in direct communication with the mainframe 113, i.e., accessed by mainframe robot 120, or alternatively, the annealing station 135 may be position in communication with the mainframe 113, i.e., the annealing station may be positioned on the same system as mainframe 113, but may not be in direct contact with the mainframe 113 or accessible from the mainframe robot 120. For example, as illustrated in FIG. 1, the anneal station 135 may be positioned in direct communication with the link tunnel 115, which allows for access to mainframe 113, and as such, the anneal chamber 135 is illustrated as being in communication with the mainframe 113.

As mentioned above, ECP system 100 also includes a processing mainframe 113 having a substrate transfer robot 120 centrally positioned thereon. Robot 120 generally includes one or more arms/blades 122, 124 configured to support and transfer substrates thereon. Additionally, the robot 120 and the accompanying blades 122, 124 are generally configured to extend, rotate, and vertically move so that the robot 120 may insert and remove substrates to and from a plurality of processing cells 102, 104, 106, 108, 110, 112,114,116 positioned on the mainframe 113. Similarly, factory interface robot 132 also includes the ability to rotate, extend, and vertically move its substrate support blade, while also allowing for linear travel along the robot track that extends from the factory interface 130 to the mainframe 113. Generally, process cells 102, 104, 106, 108, 110, 112, 114, 116 may be any number of processing cells utilized in an electrochemical plating platform. More particularly, the process cells may be configured as electrochemical plating cells, rinsing cells, bevel clean cells, spin rinse dry cells, substrate surface cleaning cells (which collectively includes cleaning, rinsing, and etching cells), electroless plating cells, metrology inspection stations, and/or other processing cells that may be beneficially used in conjunction with a plating platform. Each of the respective processing cells and robots are generally in communication with a process controller 111, which may be a microprocessor-based control system configured to receive inputs from both a user and/or various sensors positioned on the system 100 and appropriately control the operation of system 100 in accordance with the inputs.

In the exemplary plating system illustrated in FIG. 1, the processing cells may be configured as follows. Processing cells 114 and 116 may be configured as an interface between the wet processing stations on the mainframe 113 and the dry processing regions in the link tunnel 115, annealing chamber 135, and the factory interface 130. The processing cells located at the interface locations may be spin rinse dry cells and/or substrate cleaning cells. More particularly, each of cells 114 and 116 may include both a spin rinse dry cell and a substrate cleaning cell in a stacked configuration. Cells 102, 104,110, and 112 may be configured as plating cells, either electrochemical plating cells or electroless plating cells, for example. Cells 106, 108 may be configured as substrate bevel cleaning cells. Additional configurations and implementations of an electrochemical processing system are illustrated in commonly assigned U.S. patent application Ser. No. 10/435,121 filed on Dec. 19, 2002 entitled “Multi-Chemistry Electrochemical Processing System”, which is incorporated herein by reference in its entirety.

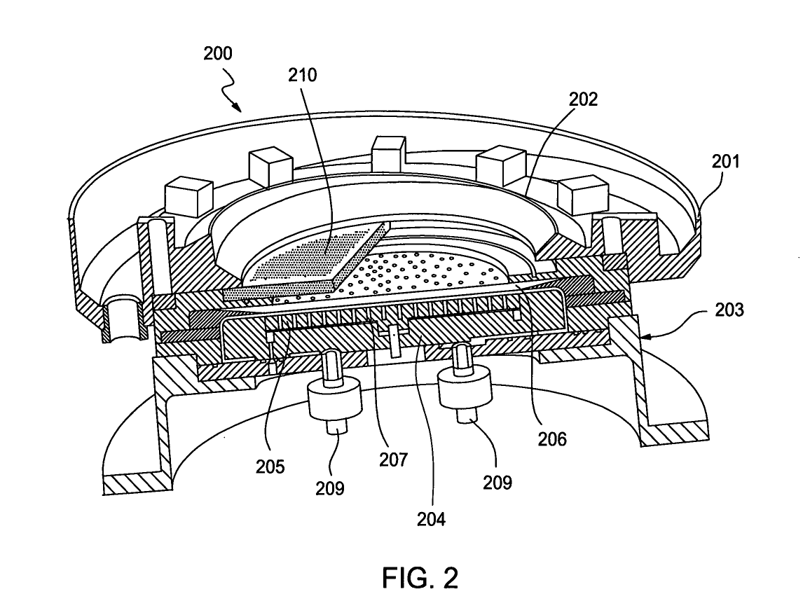

FIG. 2 illustrates a partial perspective and sectional view of an exemplary plating cell 200 that may be implemented in processing cell locations 102, 104, 110, and 112. The electrochemical plating cell 200 generally includes an outer basin 201 and an inner basin 202 positioned within outer basin 201. Inner basin 202 is generally configured to contain a plating solution that is used to plate a metal, e.g., copper, onto a substrate during an electrochemical plating process. During the plating process, the plating solution is generally continuously supplied to inner basin 202 (at about 1 gallon per minute for a 10 liter plating cell, for example), and therefore, the plating solution continually overflows the uppermost point (generally termed a “weir”) of inner basin 202 and is collected by outer basin 201 and drained therefrom for chemical management and recirculation. Plating cell 200 is generally positioned at a tilt angle, i.e., the frame portion 203 of plating cell 200 is generally elevated on one side such that the components of plating cell 200 are tilted between about 3° and about 30°, or generally between about 4° and about 10° for optimal results. The frame member 203 of plating cell 200 supports an annular base member on an upper portion thereof. Since frame member 203 is elevated on one side, the upper surface of base member 204 is generally tilted from the horizontal at an angle that corresponds to the angle of frame member 203 relative to a horizontal position. Base member 204 includes an annular or disk shaped recess formed into a central portion thereof, the annular recess being configured to receive a disk shaped anode member 205. Base member 204 further includes a plurality of fluid inlets/drains 209 extending from a lower surface thereof. Each of the fluid inlets/drains 209 are generally configured to individually supply or drain a fluid to or from either the anode compartment or the cathode compartment of plating cell 200. Anode member 205 generally includes a plurality of slots 207 formed therethrough, wherein the slots 207 are generally positioned in parallel orientation with each other across the surface of the anode 205. The parallel orientation allows for dense fluids generated at the anode surface to flow downwardly across the anode surface and into one of the slots 207. Plating cell 200 further includes a membrane support assembly 206. Membrane support assembly 206 is generally secured at an outer periphery thereof to base member 204, and includes an interior region configured to allow fluids to pass therethrough. A membrane 208 is stretched across the support 206 and operates to fluidly separate a catholyte chamber and anolyte chamber portions of the plating cell. The membrane support assembly may include an o-ring type seal positioned near a perimeter of the membrane, wherein the seal is configured to prevent fluids from traveling from one side of the membrane secured on the membrane support 206 to the other side of the membrane. A diffusion plate 210, which is generally a porous ceramic disk member is configured to generate a substantially laminar flow or even flow of fluid in the direction of the substrate being plated, is positioned in the cell between membrane 208 and the substrate being plated. The exemplary plating cell is further illustrated in commonly assigned U.S. patent application Ser. No. 10/268,284, which was filed on Oct. 9, 2002 under the title “Electrochemical Processing Cell”, claiming priority to U.S. Provisional Application Ser. No. 60/398,345, which was filed on Jul. 24, 2002, both of which are incorporated herein by reference in their entireties.

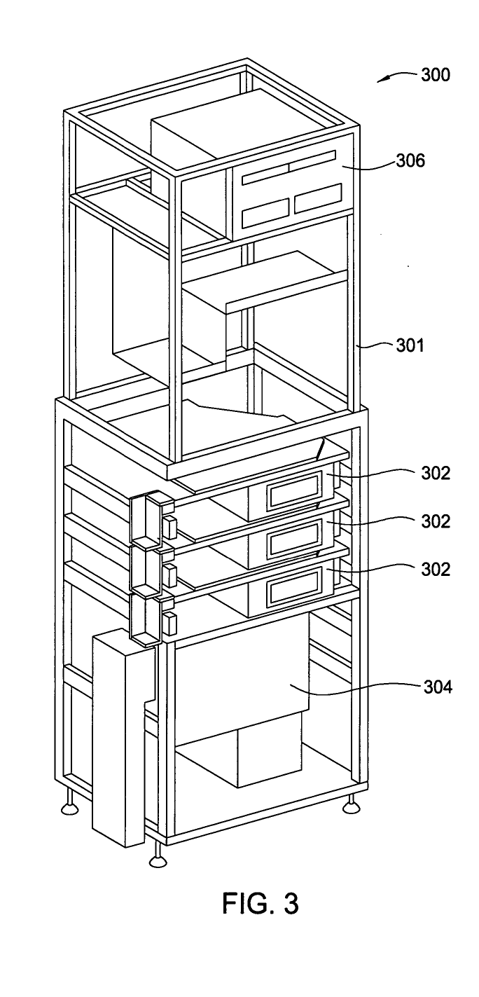

FIG. 3 illustrates a perspective view of an exemplary stacked annealing system 300 of the invention. The stacked annealing system 300 may be positioned at the annealing station 135 described in FIG. 1, or at another location on a processing platform, as desired. Annealing system 300 generally includes a frame 301 configured to support the various components of the annealing system 300. At least one annealing chamber 302 is positioned on the frame member 301 at a height that facilitates access thereto by a robot in the processing system, Le., mainframe robot 120 or factory interface robot 132.

In the illustrated embodiment, the annealing system 300 includes three (3) annealing chambers 302 stacked vertically on top of one another. However, embodiments of the invention are not intended to be limited to any particular number of annealing chambers or any particular spacing or orientation of the chambers relative to each other, as various spacing, numbers, and orientations may be implemented without departing from the scope of the invention. The annealing system 300 includes an electrical system controller 306 positioned on an upper portion of the frame member 301. The electrical system controller 306 generally operates to control the electrical power provided to the respective components of the annealing system 300, and in particular, the electrical system controller 306 operates to control the electrical power delivered to a heating element of the annealing chamber 302 so that the temperature of the annealing chamber may be controlled. Annealing system further includes fluid and gas supply assembly 304 positioned on the frame member 301, generally below the annealing chambers 302. The fluid and gas supply assembly 304 is generally configured to supply an annealing processing gas, such as nitrogen, argon, helium, hydrogen, or other inert gases that are amenable to semiconductor processing annealing, to the respective annealing chambers 302. Fluid and gas supply assembly 304 is also configured to supply and regulate fluids delivered to the annealing chamber 302, such as a cooling fluid used to cool the chamber body 302 and/or annealed substrates after the heating portion of the annealing process is completed. The cooling fluid, for example, may be a chilled or cooled water supply. Supply assembly 304 may further include a vacuum system (not shown) that is individually in communication with the respective annealing chambers 302. The vacuum system may operate to remove ambient gases from the annealing chambers 302 prior to beginning the annealing process and may be used to support a reduced pressure annealing process. Therefore, the vacuum system allows for reduced pressure annealing processes to be conducted in the respective annealing chambers 302, and further, varying reduced pressures may be simultaneously used in the respective annealing chambers 302 without interfering with the adjoining chamber 302 in the stack. Additionally, the anneal frame member 301 may also include a substrate inspection system 160 positioned thereon, which may also be accesses by robot 132.

As noted above, the processing mainframe 113 generally includes plating cells, rinse cells, clean cells, and/or other processing cells that may be useful in an electrochemical plating process sequence. A more detailed description of these cells may be found in commonly assigned U.S. patent application Ser. No. 10/616,284, entitled “Multi-Chemistry Plating System”, filed on Jul. 8, 2003, which is hereby incorporated by reference in its entirety.

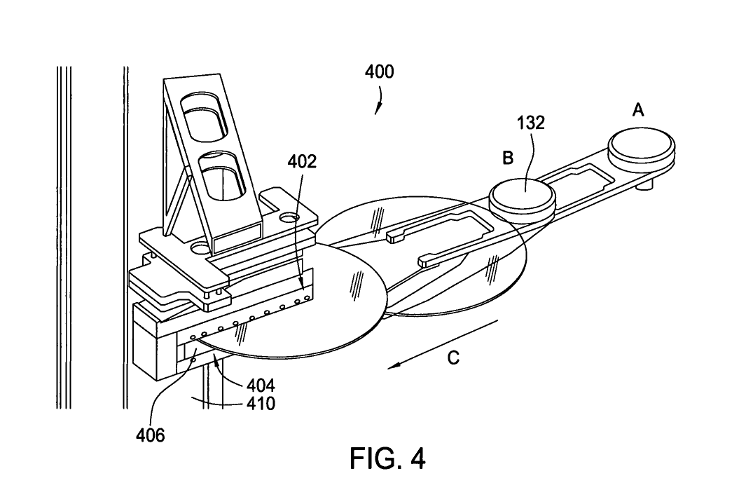

FIG. 4 illustrates a perspective view of an exemplary substrate inspection station 400 that may be implemented onto the processing system 100 of the invention. Inspection station 400 generally includes a structure shaped to receive a portion of a substrate therein, and more particularly, station 400 may include a top portion 402 and a bottom portion 404 that is spaced from the top portion 402. The spacing between the top 402 and the bottom 404 generally defines a substrate receiving slot 406. In this configuration sensors and/or analysis devices, which will be further discussed herein, may be positioned in either the top 402 and/or bottom 404 portions, such that the sensors/analysis devices may be directed toward a substrate inserted into the slot 406. Station 400 may be positioned in the factory interface 130, the link tunnel 115, or on the processing mainframe 113, for example. The inspection station 400 is generally in electrical communication with the system controller 111, and as such, the inspection station 400 is configured to measure a substrate under the control of the system controller 111, and further, the inspection station is configured to transmit information representative of the measurements to the system controller 111 for use in controlling future processing steps. This feature is particularly useful in controlling a seed layer repair process in an electrochemical plating cell, for example.

A substrate may be inserted into slot 406 by a substrate transport robot, such as robot 132, for example. FIG. 4 illustrates a substrate insertion sequence where a robot arm 132 is first positioned at location “A”, which is outside of the slot 406. The robot arm 132 is then actuated in the direction of arrow “C” to insert the substrate into the slot 406, as illustrated by arm 132 at location “B”. In this configuration, sensors positioned on the upper 402 and/or lower 404 portions of the inspection station 400 are able to take measurement along a radius of the substrate during the insertion. Similarly, the sensors may also be used to take measurements during the process of removing the substrate from the slot 406.

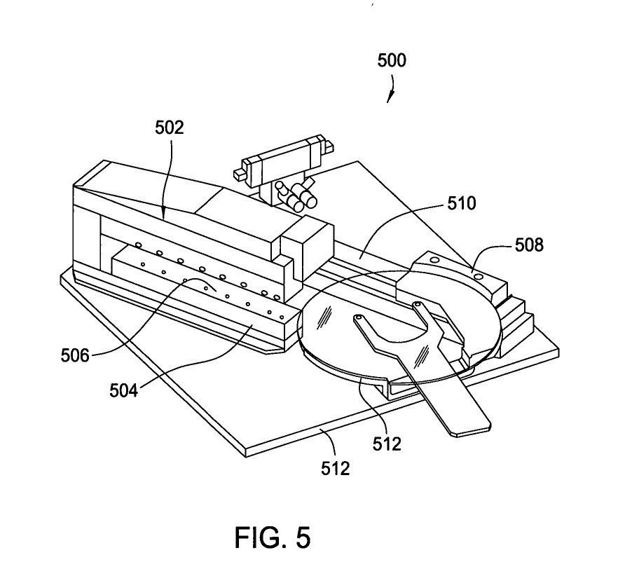

FIG. 5 illustrates another embodiment of an inspection station 500 of the invention. Station 500 includes a base member 511 having the inspection apparatus mounted thereon. The inspection apparatus generally includes a top portion 502, a bottom portion 504, and a slot 506 that is formed by the spacing of the top 502 from the bottom 504. More particularly, the top 502 and bottom portion 504 are spaced such that a substrate may be inserted into the slot 506 point where the center of the substrate is within the slot 506. Station 500 also includes a substrate carrier assembly 508. Carrier assembly generally includes a substrate support blade 512 that is attached to a movable carriage 508. Carriage 508 is generally movably positioned on a linear track 510 that is configured to cause a substrate positioned on the blade 512 to be inserted into slot 506 for measurement. Station 500 may be positioned, for example, in the factory interface 130 or link tunnel 115, or on the mainframe 113 of platform 100 illustrated in FIG. 1. More particularly, station 500 may be positioned in the anneal frame member 301 at location 160, for example. In similar fashion to inspection station 400, station 500 is generally in electrical communication with the system controller 111, and as such, the inspection station 500 is configured to measure a substrate under the control of the system controller 111, and further, the inspection station is configured to transmit information representative of the measurements to the system controller 111 for use in controlling future processing steps, such as a seed layer repair step, for example.

The substrate inspection stations 400, 500 of the invention generally utilize eddy current field measurement processes to determine the thickness of a layer deposited on a substrate. As such, the top and/or bottom portions of the respective inspection stations will include eddy current sensors, i.e., if the layer to be measured is positioned face up, then the sensors will generally be positioned at least in the top portion, and conversely, if the layer to be measured is positioned face down, then the sensors will correspondingly at least be positioned in the lower portion of the inspection station.

Generally, eddy current field sensors operate at a frequency configured to penetrate various films, conductive and often nonconductive, which generally includes the dielectric layers positioned between the conductive films. This is a distinction from conventional four point probe eddy current measurement devices, as the probe measurement devices measure only the top conductive layer when there is a dielectric layer under the conductive layer. This inherent property of four point probe measurement leads to inaccuracy in instances where the sheet resistance is not significantly greater than the conductive film resistance. For P+ doped layers, for example, substrate compensation is also required. The eddy current field sensors of the inspection stations of the invention operate similarly to conventional four point probe apparatuses in that they also measure the sheet resistance of the film, however, the field based sensors of the present invention are non-destructive, requires less correction, and are more accurate than conventional probe sensors. Once the sheet resistance of a file is determined, the thickness of the film may be derived from known mathematical methods.

However, since film resistivity is known to change with film temperature, embodiments of the invention contemplate measuring the sheet resistance of the films either before an annealing step, or alternatively, after an annealing step and after the film has had sufficient time to cool to a temperature where accurate and stable measurements may be taken. In instances where a post anneal measurement must be taken without cooling time sufficient to stabilize the film resistivity, point to point temperature compensation may be required if an accurate measurements are to be obtained.

Eddy current field sensors are desirable for use in the inspection stations of the invention, as the sensors are cost effective, are capable of accurate measurements, and provide repeatable results. Eddy current field sensors operate to determine the sheet resistance of a conductive film by creating a time varying magnetic field from a coil via application of an alternating current to the coil. The application of the current to the coil causes the coil to radiate energy, e.g., generates a circulating magnetic field. This magnetic field generates eddy currents in the conductive layer or film on the substrate when the magnetic field intersects the conductive surface. The eddy current generated in the conductive film in turn generates its own magnetic field, which inherently interacts with the magnetic field of the coil. This interaction causes a disturbance or change in the magnetic field of the coil and its corresponding electrical parameters, i.e., the impedance of the coil. This change of impedance can be directly measured and is known to be directly proportional to the thickness of the conductive layer.

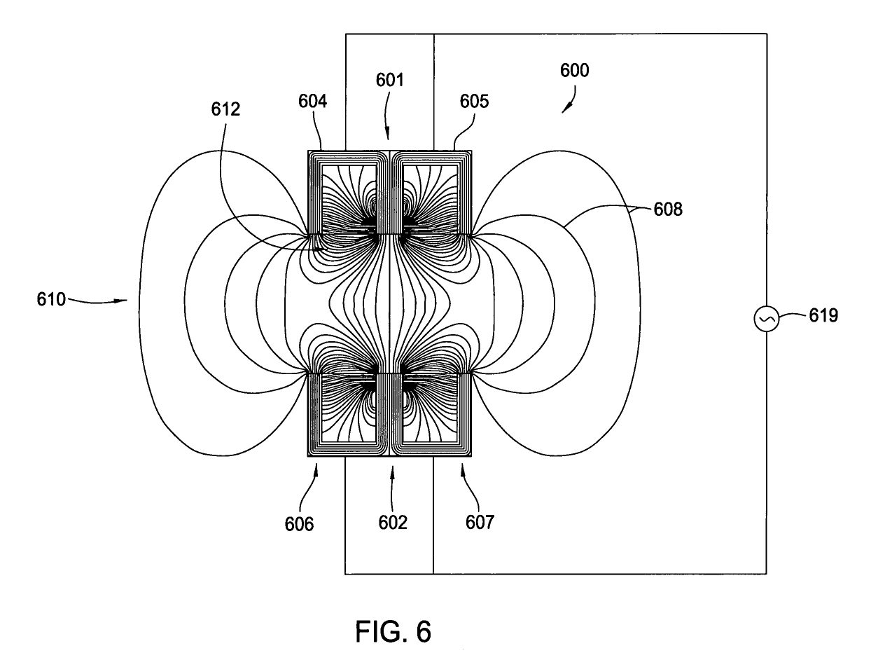

FIG. 6 illustrates an exemplary eddy current sensor 600 of the invention. Although single head eddy current sensors may be implemented in the inspection station of the invention, single head sensors have been known to generate undesirable signal to distance sensitivities. However, the double head sensor 600 of the invention has been shown to generate a signal to distance sensitivity that is reduced by about two orders of magnitude over conventional single head sensors. The double head sensor 600 generally includes a top 601 and bottom 602 portions. The top portion 601 includes a first 604 and second 605 coils, while the bottom portion 602 includes a first 606 and second 607 coils. When alternating current is applied to the coils, the resulting magnetic field 608 is generated. The magnetic field 608 is denser, i.e., has greater flux, than the magnetic field generated by a single coil sensor. As such, the sensitivity of the double head sensor 600 is increased. Further, the magnetic field 608 increases in density/flux in the region labeled 612, which is proximate, each of the respective coils 604, 605, 606, 607. A substrate placed in this region would interact with a substantially stronger field, i.e., the substrate would encounter a substantially higher flux. Placing the substrate in the region of dense flux/field 612 results in a greater induced current or eddy current being generated in the conductive film, which increases the measurable interference with field 608. A source of alternating current 614 is positioned to supply current to the respective coils during the measurement process.

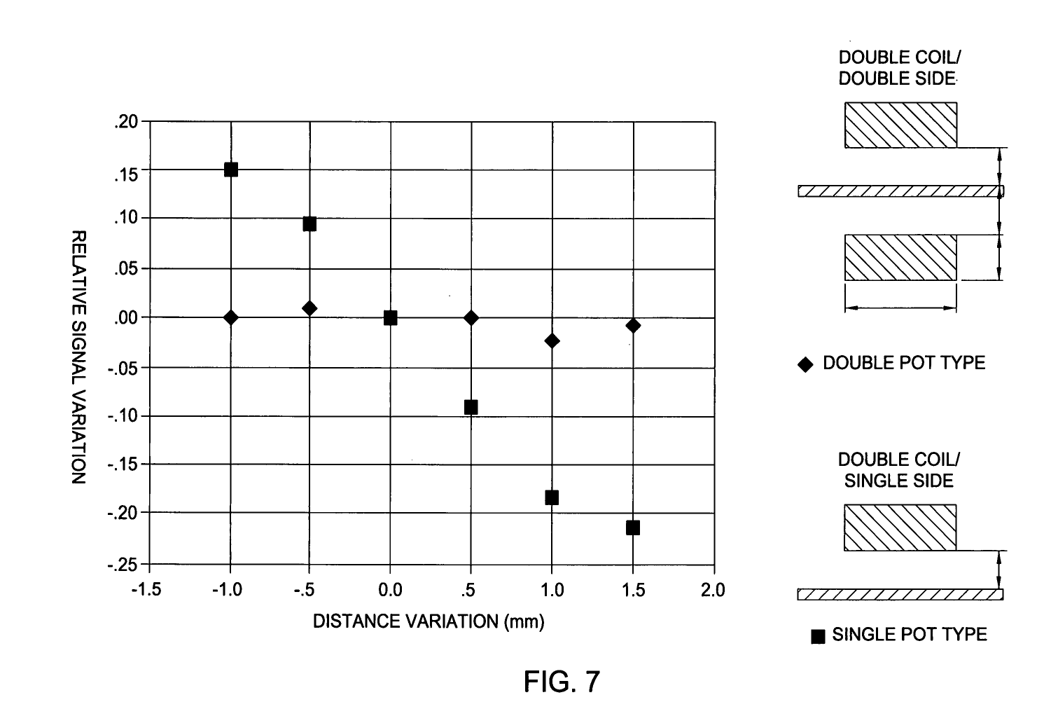

As noted above, the double coil configuration illustrated in FIG. 6 also provides substantially reduced sensitivity of amplitude change to distance variation. For example, FIG. 7 illustrates a plot of relative signal variation verses distance variation for both a double coil double side configuration (the embodiment illustrated in FIG. 6), and a double coil single side configuration. The variation plot illustrates that the embodiment of the coils illustrated in FIG. 6, i.e., the double coil double side positioning embodiment generates substantially less relative signal variation compared to a double coil single sided configuration.

In operation, the thickness of a conductive layer on a substrate may be measured by inspection stations 400, 500 at essentially any time during an electrochemical plating process. Generally, substrates will be inspected prior to any plating operations so that the thickness of the seed layer on the substrate may be determined, or alternatively, after the plating process is completed so that the thickness of the plated layer may be determined. The inspection process generally includes activating the eddy current sensing coils of the respective inspection station 400, 500, and then inserting the substrate into the inspection station slot for measurement. The insertion process should be accomplished at a constant rate, as the inspection stations are generally configured to collect data points at predetermined time intervals, and as such, a constant insertion velocity assists with obtaining an accurate data curve representative of the film thickness.

More particularly, the insertion process is generally configured to be completed in less than about 3 seconds, and during this time period, the inspection stations 400, 500 are generally configured to collect between about 100 and about 2000 data points, for example. The substrate is generally inserted along a linear path that intersects the center of the substrate, or at least intersects an area proximate the center of the substrate. Further, the eddy current sensing coils are generally positioned so that the magnetic field variations in the coil may be measured along the same linear path that generally intersects the geometric center of the substrate. As such, the thickness measurement is generally taken along a radius of the substrate and extends from the bevel edge to the center of the substrate.

The double head and double coil configuration has been shown to generate a signal to distance sensitivity of less than about % 5 ΔV/1 mm for distances of between about 1.8 mm and about 2.2 mm (sensor to substrate). Further, this configuration has been shown to provide an accuracy of between about 1% and about 2% and a repeatability without calibration of less than about 1% per month of continuous fabrication operation, and more particularly, a repeatability without calibration of less than about 0.2% per month of continuous fabrication operation.

Once the thickness of the substrate along the radius is measured, the thickness profile information may be transmitted to the system controller 111. System controller 111 may then use the measured thickness information to modify a processing recipe. For example, if the thickness of a seed layer on a substrate is measured to be thinner than desired, then the system controller may modify the plating processing recipe to increase the deposited thickness of a layer in a seed layer repair process.

While the foregoing is directed to embodiments of the present invention, other and further embodiments of the invention may be devised without departing from the basic scope thereof, and the scope thereof is determined by the claims that follow.

1. A substrate processing platform, comprising:
a mainframe having a plurality of fluid processing cells positioned thereon;
a loading station in communication with the mainframe; and
a substrate inspection station positioned in the loading station, the substrate inspection station comprising an eddy current sensor having a dual coil dual sided sensing assembly.

2. The processing platform of claim 1, wherein the substrate inspection station comprises a top and bottom members separated by a substrate receiving slot.

3. The processing platform of claim 2, wherein a first pair of eddy current sensing coils are positioned on the top member and a second pair of eddy current sensing coils are positioned on the bottom member.

4. The processing platform of claim 2, further comprising a substrate support carriage movable positioned to insert a substrate into the slot.

5. An eddy current sensor for determining the thickness of a layer deposited on a substrate, comprising:
a first pair of coils positioned above a substrate receiving slot;
a second pair of coils positioned below the substrate receiving slot;
a source of alternating current in electrical communication with the first and second pair of coils;
a substrate transfer robot positioned to insert a substrate into the substrate receiving slot; and
a controller in electrical communication with the first and second pair of coils and the robot.

6. A method for determining the thickness of a conductive layer on a substrate, comprising:
activating a first and second pair of coils positioned on opposing sides of a substrate receiving slot;
inserting the substrate into the slot along a linear path at a constant velocity;
measuring an eddy current field effect on a magnetic field generated by the first and second pair of coils; and
calculating the thickness of the conductive layer from the measured eddy current field effect.

7. The method of claim 6, further comprising controlling the activating, inserting, measuring, and calculating with a microprocessor based controller.

8. The method of claim 7, wherein the calculated thickness comprises a thickness of a seed layer on a substrate.

9. The method of claim 8, further comprising controlling a plating operation on the seed layer in accordance with the measured thickness.
